(19) United States
(12) Patent Application Publication
(10) Pub. No.: US 2024/0330692 A1
(43) Pub. Date: Oct. 3, 2024

(54) SEARCHING AN OPTIMAL COMBINATION OF HYPERPARAMETERS FOR A MACHINE LEARNING MODEL

(71) Applicant: STMicroelectronics International N. V., Geneva (CH)

(72) Inventors: He Huang, Paris (FR); Basile Wolfrom, La Garde (FR)

(21) Appl. No.: 18/612,257

(22) Filed: Mar. 21, 2024

(30) Foreign Application Priority Data
Mar. 28, 2023 (FR) 2302973

(51) Int. Cl. G06N 3/09

(52) U.S. Cl. CPC G06N 3/09

(57) ABSTRACT

According to one aspect, a method for searching, using a computer, for an optimal combination of hyperparameters allows an automatic learning model to be defined. The method includes several hyperparameter combination tests, each hyperparameter combination test including cross-validation, using a validation data set, the cross-validation defining several performance tests, each hyperparameter combination test being stopped if a performance test score is lower than a best score, the cross-validation further including updating the best score when all of the performance scores computed for this cross-validation are higher than the best score, the updated best score then corresponding to the lowest performance score from among the set of performance scores computed for this cross-validation.

### CROSS-REFERENCE TO RELATED APPLICATIONS

This application claims the benefit of French Patent Application No. 2302973, filed on Mar. 28, 2023, which application is hereby incorporated herein by reference.

### TECHNICAL FIELD

Embodiments and implementations relate to machine learning, in particular to optimizing hyperparameters of a machine learning model.

### BACKGROUND

Machine learning is a branch of artificial intelligence that enables a computer system to learn from data, without having been explicitly programmed to perform a given task.

Machine learning enables a machine to acquire knowledge and skills from a data set in order to make predictions, carry out classifications or perform other types of processing operations on new data.

A machine learning model is a mathematical representation of a system or a process that enables a machine to learn from data. The model is created using a machine learning algorithm that learns from a training data set to produce a predicted output for a given input.

The choice of model depends on the type of problem to be solved and the characteristics of the available data. Different types of machine learning model exist. Examples include linear models, decision trees, and artificial neural networks.

Machine learning uses defined hyperparameters to train a model. Hyperparameters are parameters that are defined before starting training the model.

The hyperparameters can, for example, include a learning rate (factor determining the size of the steps taken to update the weights of the model during training), a number of iterations (number of times the model runs through the data set during training), and a model structure (number of layers for an artificial neural network and the number of neurons per layer, for example).

Hyperparameters can have a significant impact on model performance. Hyperparameters that improve or optimize the model's results should thus be sought, i.e., optimized.

Hyperparameter optimization is a method wherein several combinations of hyperparameters are evaluated on a validation data set.

Various hyperparameter search methods exist. These methods include a grid search, random search, and Bayesian search, for example.

The hyperparameters can be tested using cross-validation. Cross-validation is a technique used to evaluate the performance of hyperparameters associated with a machine learning model.

Cross-validation includes conducting several tests for the same combination of hyperparameters of a model using the same validation data set. In particular, the data set is divided into several data subsets. For each test, at least one data subset is used to train the model and at least one other subset is used to evaluate the model.

For each test, the performance of the model is evaluated and a performance measure is computed (for example, accuracy or root mean square error). The performance measures obtained for each test carried out for the same combination of hyperparameters are then averaged to obtain an overall performance measure for the model. The hyperparameter combination with the best overall performance is then selected as the optimal hyperparameter combination.

Cross-validation avoids the biases associated with using a single data set to train and evaluate the model. Cross-validation also provides a more accurate estimate of the model's performance on unknown data.

However, cross-validation can be computationally time-consuming, especially if there is a large number of validation data subsets or if the validation data set is voluminous. As a result, hyperparameter optimization can be relatively slow and costly in terms of computation time.

There is thus a need to provide a solution for more quickly finding an optimal combination of hyperparameters for a machine learning model.

### SUMMARY

According to one aspect, a method for searching, using a computer, for an optimal combination of hyperparameters allows an automatic learning model to be defined. The method comprises several hyperparameter combination tests, each hyperparameter combination test including cross-validation, using a validation data set, the cross-validation defining several performance tests on at least one validation data subset, each performance test including computing a performance score, and comparing the computed performance score with a best score, the testing of the hyperparameter combination being stopped if the computed performance score is lower than the best score. The cross-validation further comprises updating the best score when all of the performance scores computed for this cross-validation are higher than the best score, the updated best score then corresponding to the lowest performance score from among the set of performance scores computed for this cross-validation. The method further includes defining an optimal combination of hyperparameters for the learning model, this optimal combination of hyperparameters corresponding to the optimal combination of hyperparameters that defined the last best score once all of the hyperparameter combination tests have been carried out.

Such a search method allows the testing of a hyperparameter combination to be stopped as soon as a cross-validation test obtains a score that is lower than the defined best score. This avoids further cross-validation tests being carried out for a hyperparameter combination that will not be selected.

Such a method thus allows an optimal combination of hyperparameters to be sought more quickly. Such a method thus reduces the time and power required to search for an optimal combination of hyperparameters, while maintaining the quality of the model defined.

Preferably, the learning model is chosen from among a linear model, a decision tree or an artificial neural network. It is important to note that these models are not exhaustive and that numerous other machine learning models used to solve different types of problems related to the application defined by the user also exist.

Advantageously, each hyperparameter combination is sought using a grid search, a random search, or a Bayesian search.

In an advantageous embodiment, the performance tests defined by the cross-validation are carried out in a given order. The method further comprises defining an order for the performance tests each time the best score is updated, with the defined order thus corresponding to the ascending order of the scores of the cross-validation performance tests used to update the best score.

Defining the order of the performance tests in this way speeds up the search for the optimal combination of hyperparameters. This is because, in general, the performance tests with the lowest performance scores are typically the same across the different hyperparameter combination tests. Thus, by starting a cross-validation with the performance tests with the lowest performance scores, a hyperparameter combination test can be stopped more quickly when the performance score associated with a performance test is lower than the best score.

According to a further aspect, a computer program comprises instructions which, when the program is executed by a computer, result in the latter implementing a method as described above. According to a further aspect, a non-transitory computer-readable media stores computer instructions for the method as described above that, when executed by a processor, cause the processor to perform the computer instructions.

According to a further aspect, a computer system comprises a non-transitory memory in which a computer program as described hereinabove is stored, and a processing unit or processor configured to implement the computer program.

### BRIEF DESCRIPTION OF THE DRAWINGS

Other advantages and features of the invention will become apparent upon examining the detailed description of non-limiting embodiments, and from the accompanying drawings in which:

FIG. 1 illustrates a computer system configured to implement a method for searching for an optimal combination of hyperparameters;

FIG. 2 illustrates a method for searching for an optimal combination of hyperparameters for a machine learning model; and

FIG. 3 illustrates microcontroller programming and on-device learning for anomaly detection.

### DETAILED DESCRIPTION OF ILLUSTRATIVE EMBODIMENTS

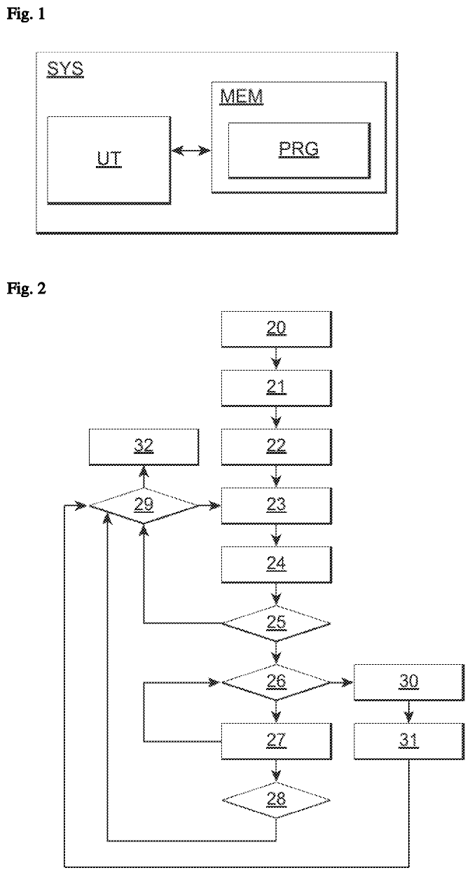

FIG. 1 shows a computer system SYS configured to implement a method for searching for an optimal combination of hyperparameters as described hereinafter with reference to FIG. 2.

The computer system SYS comprises a processing unit or processor UT and a non-transitory memory MEM. The non-transitory memory MEM is configured to store a computer program PRG. This computer program PRG comprises instructions which, when they are executed by the processing unit or processor UT, result in the latter implementing the method as described hereinafter.

FIG. 2 illustrates a method for searching for an optimal combination of hyperparameters for a machine learning model. Such a method can be implemented by a computer system SYS as described above.

The machine learning model is chosen according to an application defined by a user. The model can be a linear model, a decision tree or an artificial neural network, for example. It is important to note that these models are not exhaustive and that numerous other machine learning models used to solve different types of problems related to the application defined by the user also exist.

The machine learning model is associated with a combination of hyperparameters. In order to obtain a machine learning model with good performance, an optimal combination of hyperparameters should be sought for this machine learning model.

In particular, the hyperparameter combinations sought are tested by cross-validation. The cross-validation carried out for testing a combination of hyperparameters allows a performance of this hyperparameter combination to be measured.

The optimal combination of hyperparameters corresponds to the hyperparameter combination that obtains the best performance score from among a set of sought hyperparameter combinations. A performance score is a score that is computed based on cross-validation tests carried out when testing the same hyperparameter combination. The best performance score corresponds to the lowest score obtained for a cross-validation test associated with the optimal combination of hyperparameters.

The cross-validations can, for example, be chosen from among the following types: “Leave p out cross-validation”, “Leave one out cross-validation”, “Holdout cross-validation”, “Repeated random subsampling validation”, “k-fold cross-validation”, “Stratified k-fold cross-validation”, “Time Series cross-validation” and “Nested cross-validation”. It is important to note that these examples of cross-validation are not exhaustive and that any other type of cross-validation can be implemented within the scope of this method.

More particularly, the method comprises a step 20 of obtaining a validation data set. In this obtainment step 20, a validation data set is supplied to the computer system. These validation data are used to test the performance of various hyperparameter combinations for a machine learning model. These validation data are provided by the user.

The method further comprises a step 21 for preparing a search for an optimal combination of hyperparameters. In this preparation step 21, the validation data set is divided into several data subsets. The number of cross-validation tests to be carried out for testing a hyperparameter combination is also defined during this preparation step 21. In particular, the number of cross-validation tests is typically equal to the number of subsets defined.

The method then comprises an initialization step 22. In this initialization step 22, the best score is set to a predefined value, for example o. As described hereafter, the best score is then updated as soon as the scores obtained for all of the cross-validation tests of a hyperparameter combination test are higher than the previous defined best score. The best score will then be updated by the lowest of these various scores that are higher than the previous best score.

The method further comprises a step 23 of searching for a hyperparameter combination. The hyperparameter combination can be sought using methods well known to a person skilled in the art. For example, a hyperparameter combination can be sought by carrying out a grid search, a random search, or a Bayesian search.

The method then comprises a cross-validation to test the hyperparameter combination obtained in step 23. Cross-validation defines several cross-validation tests, corresponding to performance tests. Each performance test allows the model to be trained from at least one validation data subset and allows the model to be evaluated based on at least one other validation subset. The subsets used to train and evaluate the model are different for each performance test.

In particular, the method comprises a first cross-validation test 24. In this first cross-validation test, at least one validation data subset is used to train the model and at least one other validation subset is used to evaluate the model. This first cross-validation test is used to compute a performance score for this cross-validation test.

The method then comprises a first step 25 of evaluating the score obtained for this first cross-validation test 24 carried out. In this first evaluation step 25, the cross-validation score computed during the first test 24 is compared with the best score.

If, at the first evaluation step 25, the cross-validation score is lower than the best score, then the hyperparameter combination test is abandoned.

The first evaluation step 25 allows only the first cross-validation test associated with a hyperparameter combination to be carried out when the score of this cross-validation is lower than the best score defined. This first evaluation step 25 thus allows the testing of a hyperparameter combination to be stopped as early as the first cross-validation test 24 if the score of this cross-validation is lower than the best score defined. This avoids further cross-validation tests being carried out for a hyperparameter combination that will not be selected.

In such a case, the method then comprises a verification step 29. In this verification step 29, the number of hyperparameter combination tests carried out is compared with a maximum number of hyperparameter combination tests defined by the user.

If, in step 29, the number of hyperparameter combination tests already carried out is less than the maximum number of hyperparameter combination tests, then the method is reiterated from step 23 to test a new hyperparameter combination.

If, in the first step 25, the performance score of the first test 24 is higher than the best score, then the method comprises a step 26 to determine whether the cross-validation test carried out is the last one defined for cross-validation.

If the cross-validation test carried out is not the last one for this cross-validation, the method comprises another cross-validation test 27. This test 27 is used to compute a new performance score.

The method then comprises a step 28 of evaluating the performance score computed for the cross-validation test 27.

If the performance score of the cross-validation test is less than the best score, then the method is reiterated from step 23 to test a new hyperparameter combination, if the number of hyperparameter combination tests already carried out is less than the maximum number of hyperparameter combination tests (step 29). Thus, this second step 28 allows the testing of a hyperparameter combination to be stopped as soon as a cross-validation test obtains a performance score that is lower than the defined best score. This avoids further cross-validation tests being carried out for a hyperparameter combination that will not be selected.

If the performance score of the cross-validation test is higher than the best score, then the method is reiterated from step 26 to carry out a new cross-validation test if the cross-validation test carried out is not the last one defined for this cross-validation.

If, in step 26, the cross-validation test carried out is the last one defined for this cross-validation, then the method comprises an update step 30. In this step 30, the best score is updated with the value of the lowest performance score of the tests for this cross-validation.

The method then comprises a step 31 of updating the order of the cross-validation tests. In this step 31, the order of the cross-validation tests is defined for the next hyperparameter tests. In particular, the order of the cross-validation tests is defined depending on the score of each cross-validation in the previous hyperparameter test. The order of the cross-validation tests corresponds to the ascending order of these scores. Defining the order of the cross-validation tests in this way speeds up the search for the optimal combination of hyperparameters. This is because, in general, the cross-validation tests with the lowest performance scores are typically the same across the different hyperparameter combination tests. Thus, by starting a cross-validation with the tests with the lowest performance scores, a hyperparameter combination test can be stopped more quickly when the performance score associated with a cross-validation test is lower than the best score.

The method then further comprises the verification step 29. As mentioned hereinabove, in this verification step 29, the number of hyperparameter combination tests carried out is compared with the maximum number of hyperparameter combination tests defined by the user.

If, in step 29, the number of hyperparameter combination tests already carried out is less than the maximum number of hyperparameter combination tests, the method is then reiterated from step 23 so as to test a new hyperparameter combination.

If, in step 29, the number of hyperparameter combination tests already carried out corresponds to the maximum number of hyperparameter combination tests, then the method comprises a step 32 of defining an optimal combination of hyperparameters. In particular, the optimal combination of hyperparameters corresponds to the combination of hyperparameters for which the cross-validation defined the last best score.

Such a search method allows the testing of a hyperparameter combination to be stopped as soon as a cross-validation test obtains a score that is lower than the defined best score. This avoids further cross-validation tests being carried out for a hyperparameter combination that will not be selected.

Such a method thus allows an optimal combination of hyperparameters to be sought more quickly. Such a method thus reduces the time and power required to search for an optimal combination of hyperparameters, while maintaining the quality of the model defined.

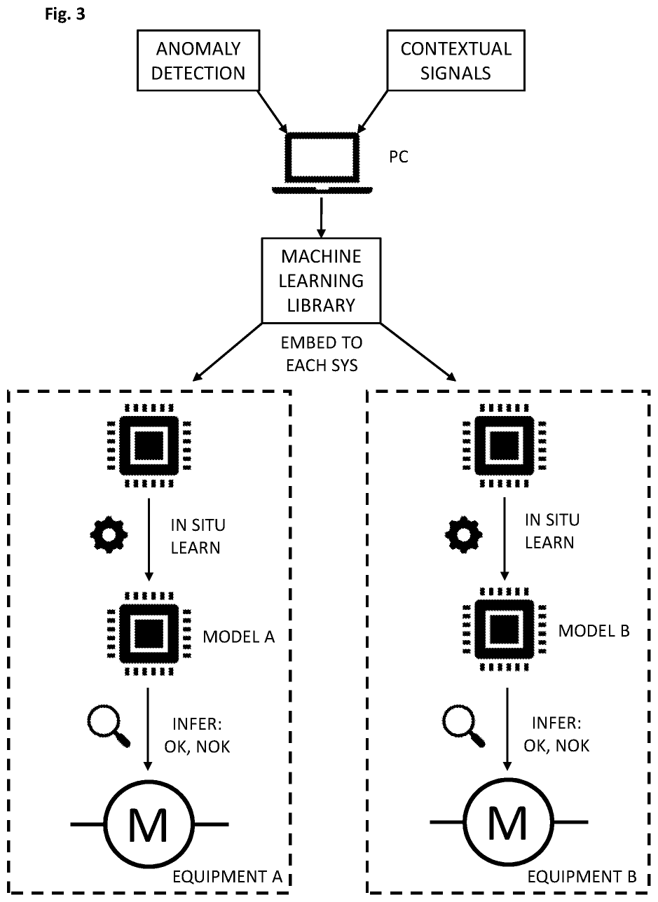

FIG. 3 illustrates a specific application of microcontroller programming and on-device learning for anomaly detection. In this embodiment, microcontrollers SYS implement incremental on-device learning, which is often used in, e.g., anomaly detection for predictive maintenance. In a first step, hyperparameter optimization is implemented on a computer such as a personal computer (PC) to create an anomaly detection machine learning library. In this step, contextual signals can be used to run optimization with, e.g., 100 cross-validations for different hyperparameter combinations, to find a machine learning library that adapts optimally to the contextual signals. An embodiment speeds up this search process, reducing the initial 100 cross-validations to, e.g., about two cross-validation tests on average with early stopping for all tests, while still maintaining 100 cross-validations for the best libraries to ensure robustness.

A second step involves implementing the machine learning library once the optimal hyperparameter combination has been found in the first step. The same self-learning engine is embedded in each of the microcontrollers, allowing them to individually learn and understand sensor patterns at the edge for their specific pieces of equipment, and incrementally gather knowledge to detect potential anomalous behaviors that vary from normal operation of the equipment.

In traditional training of static machine learning models, the number of cross-validations is often limited to a small number, such as 5 or 10, with different ways of splitting the original dataset for training and testing. For incremental on-device learning, however, the way in which the dataset is split and the sequence in which the data is trained can have significant impacts on the final performance of the model. Therefore, the number of cross-validations required is much higher than in traditional static machine learning training. In this implementation, 100 cross-validations were initially used during optimization, which required acceleration of the optimization speed. With the addition of the early stop aspect, however, the final average number of cross-validations for each hyperparameter combination test is around 2, which is much faster than the traditional way.

Additionally, the incremental on-device learning model is dynamic, where it gathers knowledge during training to become mature for inference. While this presents advantages like flexibility and adaptability, it also requires a higher level of reliability and robustness in the training method and final model. Thus, presenting the worst performance of cross-validation helps guarantee the overall performance of all cross-validations in different contexts and variations in actual implementations.

Specific applications of anomaly detection for industrial predictive maintenance include vibration analysis of industrial machines and voltage or current signal analysis of motor control. These methods can help identify potential equipment failures before they occur, minimizing downtime and allowing for proactive equipment maintenance or replacement. On-device learning can improve the accuracy and reliability of anomaly detection by adapting the model to each machine's unique behavior and environment, reducing false positives and false negatives. Furthermore, on-device learning enables continuous learning and adaptation, allowing the model to evolve and improve over time as the machine's behavior changes.

Again, the optimization speed acceleration and the early stop aspects significantly improve speed and robustness for incremental on-device learning on microcontrollers SYS, e.g., for anomaly detection.

What is claimed is:

1. A method for searching, using a computer, for an optimal combination of hyperparameters allowing an automatic learning model to be defined, the method comprising:
performing several hyperparameter combination tests, each hyperparameter combination test including cross-validation using a validation data set, the cross-validation defining several performance tests on at least one validation data subset, each performance test including:
computing a performance score;
comparing the computed performance score with a best score; and
stopping testing of this hyperparameter combination in response to the computed performance score being lower than the best score;
each cross-validation further comprising updating the best score in response to all of the performance scores computed for this cross-validation being higher than the best score, the updated best score then corresponding to a lowest performance score from among the performance scores computed for this cross-validation; and
defining the optimal combination of hyperparameters for the automatic learning model, the optimal combination of hyperparameters for the automatic learning model corresponding to the optimal combination of hyperparameters that defined a last best score once all of the hyperparameter combination tests have been carried out.

2. The method according to claim 1, further comprising:
carrying out the performance tests defined by the cross-validation in a given order; and
defining an order for the performance tests each time the best score is updated, with the defined order thus corresponding to an ascending order of the scores of the cross-validations used to update the best score.

3. The method according to claim 1, wherein the automatic learning model is selected from among a linear model, a decision tree, or an artificial neural network.

4. The method according to claim 3, wherein each hyperparameter combination is sought using a grid search, a random search, or a Bayesian search.

5. The method according to claim 3, further comprising:
carrying out the performance tests defined by the cross-validation in a given order; and
defining an order for the performance tests each time the best score is updated, with the defined order thus corresponding to an ascending order of the scores of the cross-validations used to update the best score.

6. The method according to claim 1, wherein each hyperparameter combination is sought using a grid search, a random search, or a Bayesian search.

7. The method according to claim 6, further comprising:
carrying out the performance tests defined by the cross-validation in a given order; and
defining an order for the performance tests each time the best score is updated, with the defined order thus corresponding to an ascending order of the scores of the cross-validations used to update the best score.

8. A non-transitory computer-readable media storing computer instructions for searching for an optimal combination of hyperparameters allowing an automatic learning model to be defined that, when executed by a processor, cause the processor to perform the steps of:
performing several hyperparameter combination tests, each hyperparameter combination test including cross-validation using a validation data set, the cross-validation defining several performance tests on at least one validation data subset, each performance test including:
computing a performance score;
comparing the computed performance score with a best score; and
stopping testing of this hyperparameter combination in response to the computed performance score being lower than the best score;
each cross-validation further comprising updating the best score in response to all of the performance scores computed for this cross-validation being higher than the best score, the updated best score then corresponding to a lowest performance score from among the performance scores computed for this cross-validation; and
defining the optimal combination of hyperparameters for the automatic learning model, the optimal combination of hyperparameters for the automatic learning model corresponding to the optimal combination of hyperparameters that defined a last best score once all of the hyperparameter combination tests have been carried out.

9. The non-transitory computer-readable media according to claim 8, storing further computer instructions that cause the processor to perform the steps of:
carrying out the performance tests defined by the cross-validation in a given order; and
defining an order for the performance tests each time the best score is updated, with the defined order thus corresponding to an ascending order of the scores of the cross-validations used to update the best score.

10. The non-transitory computer-readable media according to claim 8, storing further computer instructions that cause the processor to select the automatic learning model from among a linear model, a decision tree, or an artificial neural network.

11. The non-transitory computer-readable media according to claim 10, storing further computer instructions that cause the processor to perform the steps of seeking each hyperparameter combination using a grid search, a random search, or a Bayesian search.

12. The non-transitory computer-readable media according to claim 10, storing further computer instructions that cause the processor to perform the steps of:
carrying out the performance tests defined by the cross-validation in a given order; and
defining an order for the performance tests each time the best score is updated, with the defined order thus corresponding to an ascending order of the scores of the cross-validations used to update the best score.

13. The non-transitory computer-readable media according to claim 8, storing further computer instructions that cause the processor to perform the steps of seeking each hyperparameter combination using a grid search, a random search, or a Bayesian search.

14. The non-transitory computer-readable media according to claim 13, storing further computer instructions that cause the processor to perform the steps of:
carrying out the performance tests defined by the cross-validation in a given order; and
defining an order for the performance tests each time the best score is updated, with the defined order thus corresponding to an ascending order of the scores of the cross-validations used to update the best score.

15. A computer system configured to search for an optimal combination of hyperparameters allowing an automatic learning model to be defined, the computer system comprising:
a non-transitory memory comprising instructions; and
a processor in communication with the non-transitory memory, wherein the processor executes the instructions to:
perform several hyperparameter combination tests, each hyperparameter combination test including cross-validation using a validation data set, the cross-validation defining several performance tests on at least one validation data subset, each performance test including:
computing a performance score;
comparing the computed performance score with a best score; and
stopping testing of this hyperparameter combination in response to the computed performance score being lower than the best score;
each cross-validation further comprising updating the best score in response to all of the performance scores computed for this cross-validation being higher than the best score, the updated best score then corresponding to a lowest performance score from among the performance scores computed for this cross-validation; and
define the optimal combination of hyperparameters for the automatic learning model, the optimal combination of hyperparameters for the automatic learning model corresponding to the optimal combination of hyperparameters that defined a last best score once all of the hyperparameter combination tests have been carried out.

16. The computer system according to claim 15, wherein the processor executes the instructions to:
carry out the performance tests defined by the cross-validation in a given order; and
define an order for the performance tests each time the best score is updated, with the defined order thus corresponding to an ascending order of the scores of the cross-validations used to update the best score.

17. The computer system according to claim 15, wherein the processor executes the instructions to select the automatic learning model from among a linear model, a decision tree, or an artificial neural network.

18. The computer system according to claim 17, wherein the processor executes the instructions to seek each hyperparameter combination using a grid search, a random search, or a Bayesian search.

19. The computer system according to claim 17, wherein the processor executes the instructions to:
carry out the performance tests defined by the cross-validation in a given order; and
define an order for the performance tests each time the best score is updated, with the defined order thus corresponding to an ascending order of the scores of the cross-validations used to update the best score.

20. The computer system according to claim 15, wherein the processor executes the instructions to seek each hyperparameter combination using a grid search, a random search, or a Bayesian search.
